(19) United States
(12) Patent Application Publication
(10) Pub. No.: US 2011/0238683 A1
(43) Pub. Date: Sep. 29, 2011

(54) SYSTEM AND METHOD FOR SPARQL-QUERY PROCESSING USING THE PARAMETRIZED-SPARQL-QUERY IN BASED DBMS

(76) Inventors: Jae Han Kim, Seoul (KR); Seung Woo Lee, Daejeon (KR); Won Kyung Sung, Daejeon (KR); Dong In Park, Seoul (KR); Pyung Kim, Daejeon (KR); Han Min Jung, Daejeon (KR); Sun Hwa Hahn, Daejeon (KR)

(21) Appl. No.: 13/133,523

(22) PCT Filed: Dec. 17, 2008
(86) PCT No.: PCT/KR08/07472

§ 371 Date: Jun. 8, 2011

(30) Foreign Application Priority Data
Dec. 15, 2008 (KR) 10-2008-0127507

(51) Int. Cl. G06F 17/30

(52) U.S. Cl. 707/760; 707/E17.108

(57) ABSTRACT

A Database Management System (DBMS)-based Semantic Web query system and method using parameterized SPARQL queries are provided. The present invention is configured to include output means that creates a parameter list from a SPARQL query statement, converts the query statement into an SQL statement and stores a PREPARED STATEMENT (PS) object in association with the SQL statement, thereby outputting query results. Accordingly, the query time of a Semantic Web service can be reduced, thereby improving QoS.

### TECHNICAL FIELD

The present invention relates generally to a Database Management System (DBMS)-based Semantic Web query system and method which is capable of improving the speed of processing of Semantic Web queries using SPARQL query statements. More particularly, the present invention relates to a DBMS-based Semantic Web query system and method using parameterized SPARQL queries, which is capable of reducing the time for processing DBMS-based Semantic Web queries using a parameterized SPARQL query scheme.

### BACKGROUND ART

The data used in Semantic Web services is a collection of RDF triples, and uses a relational DBMS database management system as a storage structure.

Furthermore, in the querying of Semantic Web services, a SPARQL query statement format is used. In order for a SPARQL query statement to be executed by a DBMS, the SPARQL query statement must be converted into an SQL statement in a form that can be processed by a commercial DBMS. Accordingly, a Semantic Web service that uses a DBMS as a storage device requires such a SPARQL-TO-SQL converter.

Accordingly, a prior art DBMS-based Semantic Web query system includes an SPARQL-TO-SQL converter 10 and a DBMS 20, as shown in FIG. 1.

The SPARQL-TO-SQL converter 10 parses an SPARQL query statement and converts the SPARQL query statement into an SQL statement using the results of the parsing. Meanwhile, the DBMS 20 receives the query statement which was converted into the SQL statement, and outputs corresponding query results.

In the meantime, in order to improve the query processing speed of the prior art DBMS-based Semantic Web query system constructed as described above, commercial DBMSs support a function called a Prepared Statement (hereinafter abbreviated as a ‘PS’) so as to reduce the time it takes to interpret a service query statement requested by a client and set up a plan to execute it.

Accordingly, the proposed prior art DBMS-based Semantic Web query system capable of supporting a PS function improves the processing speed by preparing a parsing process in such a way as to notify a DBMS of an SQL statement having a specific pattern in advance and activating a previously prepared PS object in such a way as to hand over only values corresponding to substantial constants (literals) to the DBMS.

However, the proposed prior art DBMS-based Semantic Web query system capable of supporting a PS function is burdensome and inconvenient in that a designer must program SQL statements for specific patterns into a DBMS.

### DISCLOSURE

### Technical Problem

Accordingly, the present invention has been made keeping in mind the above problems occurring in the prior art, and an object of the present invention is to provide a DBMS-based Semantic Web query system and method using parameterized SPARQL queries, which supports a PS function without the intervention of a Semantic Web service designer.

### Technical Solution

In order to accomplish the above object, according to a first embodiment of the present invention, there is provided a DBMS-based Semantic Web query system using parameterized SPARQL queries, including parameter list creation means for creating a parameter list from a SPARQL query statement; conversion means for converting the SPARQL query statement into an SQL statement; storage means for storing respective PS objects in association with one or more SQL statements; and a DBMS for outputting query results using a PS object stored in association with the resulting SQL statement and the previously created parameter list.

The parameter list may include literals within the SPARQL query statement.

The literals may include one or more of a year, longitude/latitude and a Universal Resource Identifier (URI).

The conversion means may replace one or more literals of the SPARQL query statement with a predetermined sign, and then convert the SPARQL query statement into an SQL statement.

The sign may be ‘?’.

The conversion means may further check whether the PS object corresponding to the resulting SQL statement has been stored in the storage means, request the PS object corresponding to the resulting SQL statement from the DBMS if, as a result of the checking, the PS object is determined not to have been stored, and further store the corresponding PS object in the storage means when the requested PS object is transmitted from the DBMS.

Furthermore, in the DBMS-based Semantic Web query system using parameterized SPARQL queries according to the first embodiment of the present invention, the DBMS may further store respective Prepared Statements (PSs) corresponding to the PS objects, receive a PS corresponding to the PS object and the previously created parameter list, and then output query results.

Additionally, according to a first embodiment of the present invention, there is provided a DBMS-based Semantic Web query method using parameterized SPARQL queries, including a parameter list creation step of creating a parameter list from a SPARQL query statement; a conversion step of converting the SPARQL query statement into an SQL statement; and a query result output step of a DBMS outputting query results using a PS object stored in association with the resulting SQL statement and the previous created parameter list.

The parameter list may include literals within the SPARQL query statement.

The literals may include one or more of a year, longitude/latitude and a URI.

The conversion step may include replacing one or more constants of the SPARQL query statement with a predetermined sign and then converting the SPARQL query statement into an SQL statement.

The sign may be ‘?’.

The conversion step may include a first sub-step of further checking whether the PS object corresponding to the resulting SQL statement has been stored in the storage means; a second sub-step of, if, as a result of the checking, the PS object is determined not to have been stored, requesting the PS object corresponding to the resulting SQL statement from the DBMS; and a third sub-step of, when the requested PS object is transmitted from the DBMS, further storing the corresponding PS object in the storage means.

The query result output step may include the DBMS receiving a PS corresponding to the PS object and the previously created parameter list, and then outputting query results.

According to the above-described construction and flow, the DBMS-based Semantic Web query system and method using parameterized SPARQL queries according to the present invention support a PS function without the intervention of a Semantic Web service designer.

### Advantageous Effects

As described above, the DBMS-based Semantic Web query system and method using parameterized SPARQL queries according to the present invention is a very useful invention that supports a PS function without the intervention of a Semantic Web service designer, thereby improving Quality of Service (QoS) by reducing the query time of a Semantic Web service.

### DESCRIPTION OF DRAWINGS

FIG. 1 is a block diagram of a prior art DBMS-based Semantic Web query system;

FIG. 2 is a block diagram of a DBMS-based Semantic Web query system using parameterized SPARQL queries, which is applied to a first embodiment according to the present invention;

FIGS. 3a to 3c illustrates a SPARQL query statement, a parameterized SQL query statement and a PS object stored in a parameterized SQL cache, respectively, in the first embodiment according to the present invention; and

FIG. 4 is a flowchart of a DBMS-based Semantic Web query method using parameterized SPARQL queries, which is applied to the first embodiment according to the present invention.

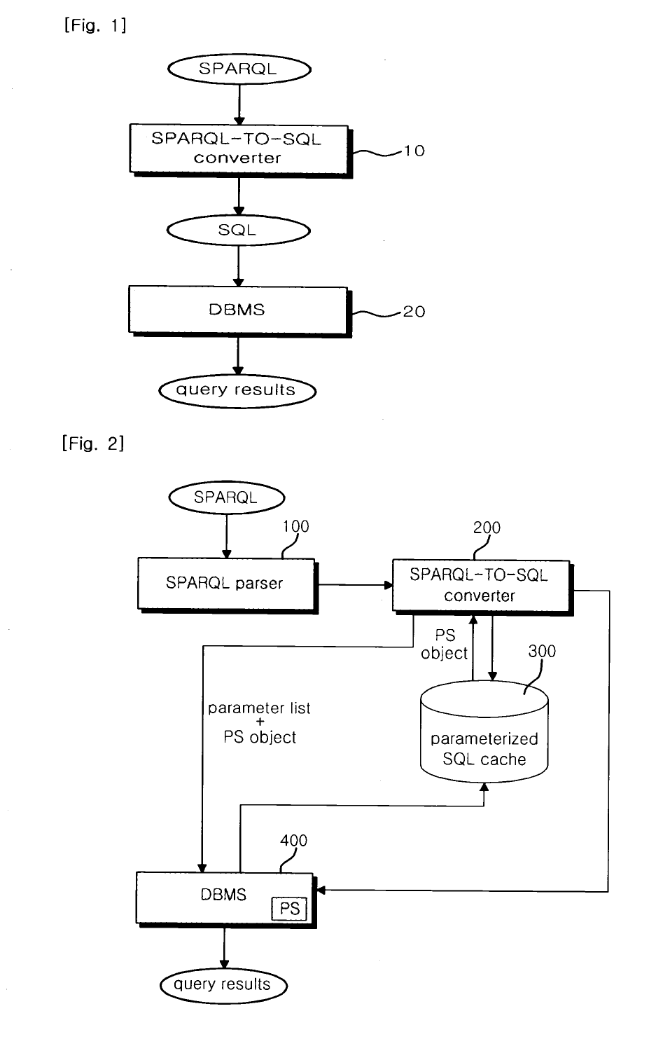

### DESCRIPTION OF REFERENCE NUMERALS OF PRINCIPAL ELEMENTS IN THE DRAWINGS

10,200: SPARQL-TO-SQL converter 11,400: DBMS
100: SPARQL 300: parameterized SQL cache

### MODE FOR INVENTION

The terms and words used in the present specification and the accompanying claims should not be limitedly interpreted as having common meanings or those found in a dictionary, but should be interpreted as having meanings suitable for the technical spirit of the present invention on the basis of the principle in which an inventor can appropriately define the concepts of terms in order to describe his or her invention in the best way.

A DBMS-based Semantic Web query system and method using parameterized SPARQL queries will be described in detail below with reference to the accompanying drawings.

FIG. 2 is a block diagram of a DBMS-based Semantic Web query system using parameterized SPARQL queries, which is applied to a first embodiment according to the present invention. In the DBMS-based Semantic Web query system using parameterized SPARQL queries, which is applied to the first embodiment according to the present invention, a SPARQL parser 100 checks whether an input SPARQL query statement conforms to a grammar and obtains parse results in tree form.

Furthermore, an SPARQL-TO-SQL converter 200 creates a parameter list including literals in the parsed SPARQL query statement, and converts the input SPARQL query statement into a parameterized SQL statement in a form that can be processed by a DBMS 400 using information about parse results obtained by the SPARQL parser 100.

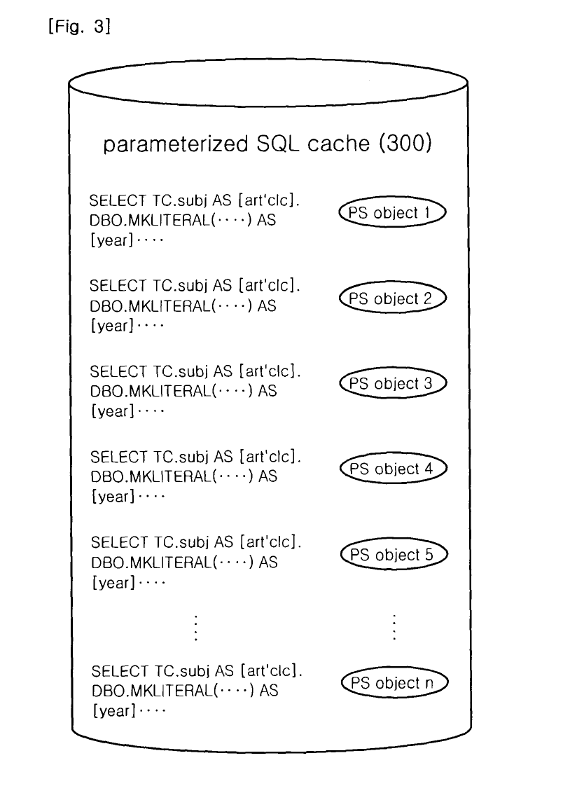

For reference, FIGS. 3a and 3b shows a SPARQL query statement and a parameterized SQL query statement, respectively, in the first embodiment of the present invention. The operation of the above-described SPARQL-TO-SQL converter 200 will be described in detail below with reference to FIGS. 3a and 3b.

The SPARQL-TO-SQL converter 200 creates a parameter list including literals, for example, ‘2000’ and ‘2008’ (year) (refer to FIG. 3a), in the input SPARQL query statement.

Meanwhile, the SPARQL-TO-SQL converter 200 converts the SPARQL query statement into a parameterized SQL statement in which each of the literals, that is, ‘2000’ and ‘2008’ (year), in the SPARQL query statement has been replaced with a predetermined sign, for example, ‘?’ (refer to FIG. 3b). Furthermore, the literals included in the parameter list may correspond to a year, longitude/latitude, and a Universal Resource Identifier (URI).

Furthermore, FIG. 3c shows an example of a PS object stored in a parameterized SQL cache in the first embodiment of the present invention. The parameterized SQL cache 300, as illustrated in FIG. 3c, assigns a unique identification code to at least one SQL statement and correspondingly stores a PS object input from the DBMS 400.

Furthermore, when the parameterized SQL statement is input from the SPARQL-TO-SQL converter 200 and a corresponding PS object exists in the input SQL statement, the parameterized SQL cache 300 outputs the corresponding PS object to the SPARQL-TO-SQL converter 200.

Accordingly, when the PS object is input from the parameterized SQL cache 300, the SPARQL-TO-SQL converter 200 transmits a previously created parameter list and the PS object to the DBMS 400 with the previously created parameter list and the PS object put in a separate array.

Furthermore, the DBMS 400 stores Prepared Statements (PSs) corresponding to respective PS objects, reads a PS corresponding to the transmitted PS object, and executes the read PS. The DBMS 400 outputs query results by inputting the PS object and literals corresponding to the sign ‘?’ included in the transmitted parameter list.

Meanwhile, if a PS object corresponding to the SQL statement input from the SPARQL-TO-SQL converter 200 does not exist, the parameterized SQL cache 300 transmits the input SQL statement to the DBMS 400. Accordingly, the DBMS 400 retransmits a PS object, in which a unique identification code has been assigned to the transmitted SQL statement, to the SPARQL-TO-SQL converter 200, and the SPARQL-TO-SQL converter 200 stores the retransmitted PS object and a corresponding SQL statement in the parameterized SQL cache 300 in an updateable manner.

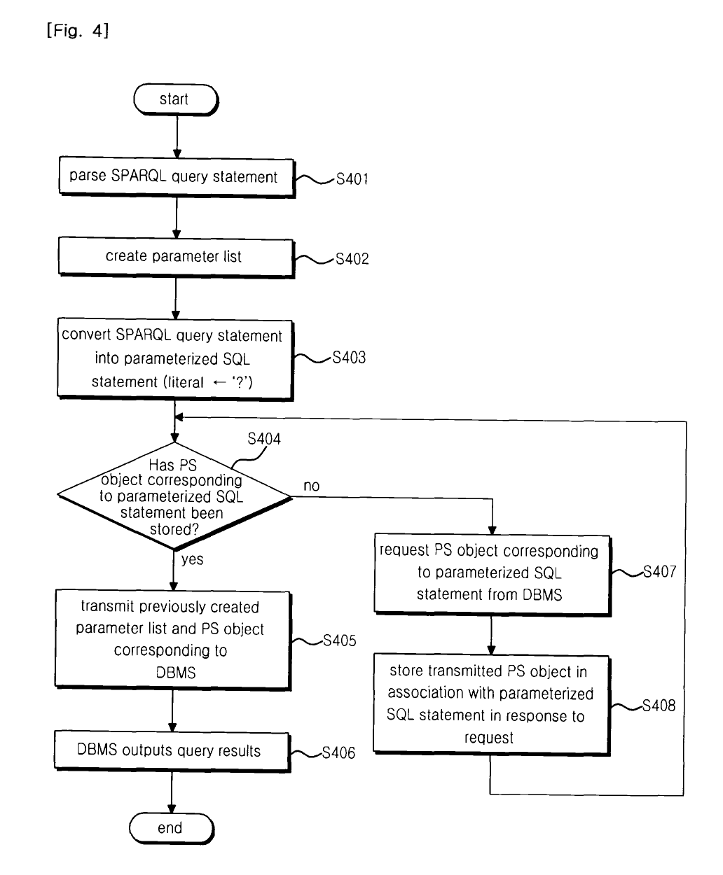

FIG. 4 is a flowchart of a DBMS-based Semantic Web query method using parameterized SPARQL queries, which is applied to the first embodiment of the present invention. The operation of the DBMS-based Semantic Web query system using parameterized SPARQL queries will be described in detail below.

First, when a SPARQL query statement is input, the SPARQL parser 100 performs a parse operation of checking whether the input SPARQL query statement conforms to a grammar and obtains parse results in tree form at step S401.

Thereafter, the SPARQL-TO-SQL converter 200 creates a parameter list including literals in the parsed SPARQL query statement at step S402. That is, the SPARQL-TO-SQL converter 200 creates a parameter list including literals, for example, ‘2000’ and ‘2008’ (year) (refer to FIG. 3a), in the input SPARQL query statement.

Furthermore, the SPARQL-TO-SQL converter 200 converts the input SPARQL query statement into a parameterized SQL statement in a form that can be processed by the DBMS 400 using information about parse results obtained by the SPARQL parser 100 at step S403. That is, the SPARQL-TO-SQL converter 200 converts the SPARQL query statement into a parameterized SQL statement in which all the literals, that is, ‘2000’ and ‘2008’ (year), in the SPARQL query statement have been replaced with predetermined signs, for example, ‘?’ (refer to FIG. 3b). The literals included in the parameter list may correspond to a year, longitude/latitude and an URI.

Thereafter, if the parameterized SQL statement is input from the SPARQL-TO-SQL converter 200 and a corresponding PS object was previously stored in the input SQL statement “Yes” at step S404), the parameterized SQL cache 300, which stores a PS object, in which a unique identification code is assigned thereto and which is input from the DBMS 400, in association with at least one SQL statement (refer to FIG. 3c), outputs the corresponding PS object to the SPARQL-TO-SQL converter 200.

Furthermore, the SPARQL-TO-SQL converter 200 transmits the previously created parameter list and the PS object input from the parameterized SQL cache 300 to the DBMS 400 with the previously created parameter list and the input PS object put in a separate array at step S405.

Accordingly, the DBMS 400 stores PSs corresponding to respective PS objects, reads a PS corresponding to the transmitted PS object and executes the read PS. That is, the DBMS 400 outputs query results by inputting the PS object and literals corresponding to the sign ‘?’ included in the transmitted parameter list at step S406.

Meanwhile, if the PS object corresponding to the SQL statement input from the SPARQL-TO-SQL converter 200 has not been stored “No” at step S404), the parameterized SQL cache 300 transmits the input SQL statement to the DBMS 400 and requests a PS object corresponding to the parameterized SQL statement at step S407.

Accordingly, the DBMS 400 transmits the PS object, in which a unique identification code has been assigned to the parameterized SQL statement, to the SPARQL-TO-SQL converter 200 in response to the request, and the SPARQL-TO-SQL converter 200 stores the PS object, transmitted in response to the request, in association with the parameterized SQL statement in the parameterized SQL cache 300 at step S408.

Although the present invention has been described in detail above in conjunction with specific examples, it will be apparent to those skilled in the art that various modifications and variations are possible within the scope of the technical spirit of the present invention, and it is natural that the modifications and variations pertain to the attached claims.

### INDUSTRIAL APPLICABILITY

The present invention relates to a DBMS-based Semantic Web query system and method, and is a very useful invention that is capable of reducing the processing time of DBMS-based Semantic Web queries using a parameterized SPARQL query scheme, so that a PS function is supported without the intervention of a Semantic Web service designer, thereby improving QoS by reducing the query time of Semantic Web services.

1. A Database Management System (DBMS)-based Semantic Web query system using parameterized SPARQL queries, comprising:
parameter list creation means for creating a parameter list from a SPARQL query statement;
conversion means for converting the SPARQL query statement into an SQL statement;
storage means for storing respective Prepared Statement (PS) objects in association with one or more SQL statements; and
a DBMS for outputting query results using a PS object stored in association with the resulting SQL statement and the previously created parameter list.

2. The DBMS-based Semantic Web query system as set forth in claim 1, wherein the parameter list comprises literals within the SPARQL query statement.

3. The DBMS-based Semantic Web query system as set forth in claim 2, wherein the literals comprise one or more of a year, longitude/latitude and a Universal Resource Identifier (URI).

4. The DBMS-based Semantic Web query system as set forth in claim 1, wherein the conversion means replaces one or more literals of the SPARQL query statement with a predetermined sign and then converts the SPARQL query statement into an SQL statement.

5. The DBMS-based Semantic Web query system as set forth in claim 4, wherein the sign is ‘?’.

6. The DBMS-based Semantic Web query system as set forth in claim 1, wherein the conversion means further checks whether the PS object corresponding to the resulting SQL statement has been stored in the storage means, requests the PS object corresponding to the resulting SQL statement from the DBMS if, as a result of the checking, the PS object is determined not to have been stored, and further stores the corresponding PS object in the storage means when the requested PS object is transmitted from the DBMS.

7. The DBMS-based Semantic Web query system as set forth in claim 4, wherein the conversion means further checks whether the PS object corresponding to the resulting SQL statement has been stored in the storage means, requests the PS object corresponding to the resulting SQL statement from the DBMS if, as a result of the checking, the PS object is determined not to have been stored, and further stores the corresponding PS object in the storage means when the requested PS object is transmitted from the DBMS.

8. The DBMS-based Semantic Web query system as set forth in claim 1, wherein the DBMS further stores respective Prepared Statements (PSs) corresponding to the PS objects, receives a PS corresponding to the PS object and the previously created parameter list, and then outputs query results.

9. The DBMS-based Semantic Web query system as set forth in claim 4, wherein the DBMS further stores respective PSs corresponding to the PS objects, receives a PS corresponding to the PS object and the previously created parameter list, and then outputs query results.

10. A DBMS-based Semantic Web query method using parameterized SPARQL queries, comprising:
a parameter list creation step of creating a parameter list from a SPARQL query statement;
a conversion step of converting the SPARQL query statement into an SQL statement; and
a query result output step of a DBMS outputting query results using a PS object stored in association with the resulting SQL statement and the previous created parameter list.

11. The DBMS-based Semantic Web query method as set forth in claim 10, wherein the parameter list comprises literals within the SPARQL query statement.

12. The DBMS-based Semantic Web query method as set forth in claim 11, wherein the literals comprises one or more of a year, longitude/latitude and a URI.

13. The DBMS-based Semantic Web query method as set forth in claim 10, wherein the conversion step comprises replacing one or more constants of the SPARQL query statement with a predetermined sign and then converting the SPARQL query statement into an SQL statement.

14. The DBMS-based Semantic Web query method as set forth in claim 13, wherein the sign is ‘?’.

15. The DBMS-based Semantic Web query method as set forth in Claim 10, wherein the conversion step comprises:
a first sub-step of further checking whether the PS object corresponding to the resulting SQL statement has been stored in the storage means;
a second sub-step of, if, as a result of the checking, the PS object is determined not to have been stored, requesting the PS object corresponding to the resulting SQL statement from the DBMS; and
a third sub-step of, when the requested PS object is transmitted from the DBMS, further storing the corresponding PS object in the storage means.

16. The DBMS-based Semantic Web query method as set forth in claim 13, wherein the conversion step comprises:
a first sub-step of further checking whether the PS object corresponding to the resulting SQL statement has been stored in the storage means;
a second sub-step of, if, as a result of the checking, the PS object is determined not to have been stored, requesting the PS object corresponding to the resulting SQL statement from the DBMS; and
a third sub-step of, when the requested PS object is transmitted from the DBMS, further storing the corresponding PS object in the storage means.

17. The DBMS-based Semantic Web query method as set forth in claim 10, wherein the query result output step comprises the DBMS receiving a PS corresponding to the PS object and the previously created parameter list, and then outputting query results.

18. The DBMS-based Semantic Web query method as set forth in claim 13, wherein the query result output step comprises the DBMS receiving a PS corresponding to the PS object and the previously created parameter list, and then outputting query results.

19. The DBMS-based Semantic Web query system as set forth in claim 2, wherein the conversion means replaces one or more literals of the SPARQL query statement with a predetermined sign and then converts the SPARQL query statement into an SQL statement.

20. The DBMS-based Semantic Web query system as set forth in claim 3, wherein the conversion means replaces one or more literals of the SPARQL query statement with a predetermined sign and then converts the SPARQL query statement into an SQL statement.

21. The DBMS-based Semantic Web query system as set forth in claim 19, wherein the sign is ‘?’.

22. The DBMS-based Semantic Web query system as set forth in claim 20, wherein the sign is ‘?’.

23. The DBMS-based Semantic Web query system as set forth in claim 2, wherein the conversion means further checks whether the PS object corresponding to the resulting SQL statement has been stored in the storage means, requests the PS object corresponding to the resulting SQL statement from the DBMS if, as a result of the checking, the PS object is determined not to have been stored, and further stores the corresponding PS object in the storage means when the requested PS object is transmitted from the DBMS.

24. The DBMS-based Semantic Web query system as set forth in claim 3, wherein the conversion means further checks whether the PS object corresponding to the resulting SQL statement has been stored in the storage means, requests the PS object corresponding to the resulting SQL statement from the DBMS if, as a result of the checking, the PS object is determined not to have been stored, and further stores the corresponding PS object in the storage means when the requested PS object is transmitted from the DBMS.

25. The DBMS-based Semantic Web query system as set forth in claim 19, wherein the conversion means further checks whether the PS object corresponding to the resulting SQL statement has been stored in the storage means, requests the PS object corresponding to the resulting SQL statement from the DBMS if, as a result of the checking, the PS object is determined not to have been stored, and further stores the corresponding PS object in the storage means when the requested PS object is transmitted from the DBMS.

26. The DBMS-based Semantic Web query system as set forth in claim 20, wherein the conversion means further checks whether the PS object corresponding to the resulting SQL statement has been stored in the storage means, requests the PS object corresponding to the resulting SQL statement from the DBMS if, as a result of the checking, the PS object is determined not to have been stored, and further stores the corresponding PS object in the storage means when the requested PS object is transmitted from the DBMS.

27. The DBMS-based Semantic Web query system as set forth in claim 2, wherein the DBMS further stores respective Prepared Statements (PSs) corresponding to the PS objects, receives a PS corresponding to the PS object and the previously created parameter list, and then outputs query results.

28. The DBMS-based Semantic Web query system as set forth in claim 3, wherein the DBMS further stores respective Prepared Statements (PSs) corresponding to the PS objects, receives a PS corresponding to the PS object and the previously created parameter list, and then outputs query results.

29. The DBMS-based Semantic Web query system as set forth in claim 19, wherein the DBMS further stores respective PSs corresponding to the PS objects, receives a PS corresponding to the PS object and the previously created parameter list, and then outputs query results.

30. The DBMS-based Semantic Web query system as set forth in claim 20, wherein the DBMS further stores respective PSs corresponding to the PS objects, receives a PS corresponding to the PS object and the previously created parameter list, and then outputs query results.

31. The DBMS-based Semantic Web query method as set forth in claim 11, wherein the conversion step comprises replacing one or more constants of the SPARQL query statement with a predetermined sign and then converting the SPARQL query statement into an SQL statement.

32. The DBMS-based Semantic Web query method as set forth in claim 12, wherein the conversion step comprises replacing one or more constants of the SPARQL query statement with a predetermined sign and then converting the SPARQL query statement into an SQL statement.

33. The DBMS-based Semantic Web query method as set forth in claim 31, wherein the sign is ‘?’.

34. The DBMS-based Semantic Web query method as set forth in claim 32, wherein the sign is ‘?’.

35. The DBMS-based Semantic Web query method as set forth in claim 11, wherein the conversion step comprises:
a first sub-step of further checking whether the PS object corresponding to the resulting SQL statement has been stored in the storage means;
a second sub-step of, if, as a result of the checking, the PS object is determined not to have been stored, requesting the PS object corresponding to the resulting SQL statement from the DBMS; and
a third sub-step of, when the requested PS object is transmitted from the DBMS, further storing the corresponding PS object in the storage means.

36. The DBMS-based Semantic Web query method as set forth in claim 12, wherein the conversion step comprises:
a first sub-step of further checking whether the PS object corresponding to the resulting SQL statement has been stored in the storage means;
a second sub-step of, if, as a result of the checking, the PS object is determined not to have been stored, requesting the PS object corresponding to the resulting SQL statement from the DBMS; and
a third sub-step of, when the requested PS object is transmitted from the DBMS, further storing the corresponding PS object in the storage means.

37. The DBMS-based Semantic Web query method as set forth in claim 31, wherein the conversion step comprises:
a first sub-step of further checking whether the PS object corresponding to the resulting SQL statement has been stored in the storage means;
a second sub-step of, if, as a result of the checking, the PS object is determined not to have been stored, requesting the PS object corresponding to the resulting SQL statement from the DBMS; and
a third sub-step of, when the requested PS object is transmitted from the DBMS, further storing the corresponding PS object in the storage means.

38. The DBMS-based Semantic Web query method as set forth in claim 32, wherein the conversion step comprises:
a first sub-step of further checking whether the PS object corresponding to the resulting SQL statement has been stored in the storage means;
a second sub-step of, if, as a result of the checking, the PS object is determined not to have been stored, requesting the PS object corresponding to the resulting SQL statement from the DBMS; and
a third sub-step of, when the requested PS object is transmitted from the DBMS, further storing the corresponding PS object in the storage means.

39. The DBMS-based Semantic Web query method as set forth in claim 11, wherein the query result output step comprises the DBMS receiving a PS corresponding to the PS object and the previously created parameter list, and then outputting query results.

40. The DBMS-based Semantic Web query method as set forth in claim 12, wherein the query result output step comprises the DBMS receiving a PS corresponding to the PS object and the previously created parameter list, and then outputting query results.

41. The DBMS-based Semantic Web query method as set forth in claim 31, wherein the query result output step comprises the DBMS receiving a PS corresponding to the PS object and the previously created parameter list, and then outputting query results.

42. The DBMS-based Semantic Web query method as set forth in claim 32, wherein the query result output step comprises the DBMS receiving a PS corresponding to the PS object and the previously created parameter list, and then outputting query results.
